(19) United States
(12) Patent Application Publication
(10) Pub. No.: US 2006/0123143 A1
(43) Pub. Date: Jun. 8, 2006

(54) Method for driving a standard interface to perform nonstandard functions

(76) Inventors: Jar-Haur Wang, Hsin-Tien City (TW); Yen bo Lai, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/030,914

(22) Filed: Jan. 10, 2005

(30) Foreign Application Priority Data
Dec. 3, 2004 (TW) 093137350

(51) Int. Cl. G06F 3/00

(52) U.S. Cl. 710/5

(57) ABSTRACT

A method for driving a standard interface to perform nonstandard functions is proposed. It includes setting a no-available parameter of a standard command frame as an execution parameter; and sending the standard command frame with the execution parameter to the standard interface. Therein, when the standard interface finds the execution parameter, the standard interface performs a corresponding one of the nonstandard functions. Thus, on the premise that the standard interface complies with the standard interface specification, the present invention provides a provides a novel way to define the command frames for driving the standard interface to perform nonstandard functions and thereby improve the flexibility of the standard interface.

### BACKGROUND OF THE INVENTION

1. Field of the Invention

The present invention is related to a method for driving a standard interface to perform nonstandard functions, and more particularly, to a method that uses no-available parameters of a standard command frame to drive the standard interface to perform nonstandard functions.

2. Description of Related Art

Since computers were invented, people have been pursuing the improvement of computers' functionality. Because the efficiency of computers is mainly affected by the storage capacity and data transfer efficiency of hard disks, people always want to increase the storage capacity and data transfer efficiency. After a lot of efforts, the conventional Advanced Technology Attachment (ATA) standard, which is an interface standard dedicated for hard disks, was developed eventually. In order to persistently develop the ATA related standards, the T13 group of National Committee for Information Technology Standards (NCITS) was assigned to develop ATA related technologies. In addition to the persistent development of the ATA related technologies, the T13 group further developed the ATA Packet Interface (ATAPI) to support the devices exclusive of hard disks.

In the ATA/ATAPI standard specification, a standard command frame is defined to drive the ATA/ATAPI interface to perform standard functions. Reference is made to FIG. 1, which is an example of the standard NOP command frame in accordance with the prior art. As shown in FIG. 1, the NOP command frame includes a Feature register parameter, a Sector Count register parameter, an LBA Low register parameter, an LBA Mid register parameter, an LBA High register parameter, a Device register parameter and a Command register parameter. Therein, the Feature register parameter is used to convey a subcommand code. The Sector Count register parameter, the LBA Low register parameter, the LBA Mid register parameter and the LBA High register parameter are no-available (na) parameters of the NOP command frame. Since the values of the no-available parameters do not affect the execution of the NOP command frame, these values usually are randomly chosen values in practice. As for the Device register parameter, its Bit 4, Bit 5 and Bit 7 are predetermined according to the standard and the others, shown as “na”, can be randomly chosen values. The Command register parameter represents a standard NOP command code.

When the NOP command frame is received by the ATA/ATAPI interface, the parameters of the NOP command frame will be stored in a corresponding registers disposed inside the ATA/ATAPI interface. It means that a Command register disposed inside the ATA/ATAPI interface will be used to store the Command register parameter of the NOP command frame and other predetermined registers will be used to store the corresponding parameters of the NOP command frame. After that, a control unit of the ATA/ATAPI interface will detect all of the registers storing the parameters of the NOP command frame and drive the ATA/ATAPI interface to perform the corresponding standard function.

Furthermore, in order to comply with the development strategies of respective companies, some values of the Command register parameter are reserved in the ATA/ATAPI standard specification, such as 9Ah, C0h˜C3h, 8xh, F0h, F7h and Fah˜FFh, and the companies can use these reserved values to define their own Vender Specific Commands. By using the Vender Specific Commands, the ATA/ATAPI interface can be driven to perform nonstandard functions. However, the number of these reserved values is finite. Once the companies want to provide more functions of the ATA/ATAPI interface, these reserved values may not be sufficient. Consequently, the prior art is not flexible enough in usage.

Therefore, in order to resolve this problem, the present invention provides a method for driving a standard interface to perform nonstandard functions. Using the present invention can remove the drawback of lack of flexibility in the prior art.

### SUMMARY OF THE INVENTION

An objective of the present invention is to provide a method for driving a standard interface to perform nonstandard functions. It sets a no-available parameter of a standard command frame as an execution parameter. When the standard interface detects the standard command frame has the execution parameter, it is driven to perform a corresponding one of the nonstandard functions. Thus, the present invention can provide a novel way to define the command frames for driving the standard interface to perform nonstandard functions and thereby improve the flexibility of the standard interface.

Another objective of the present invention is to provide a method for driving a standard interface to perform nonstandard functions activation. It sets a no-available parameter of a standard command frame as an activation parameter. When the standard interface detects the standard command frame has the activation parameter, it can confirm that a nonstandard function activation needs to be performed. In this way, the present invention can prevent the standard interface from performing the nonstandard function unexpectedly.

For achieving the objectives above, the present invention provides a method for driving a standard interface to perform nonstandard functions. The method includes setting a no-available parameter of a standard command frame as an execution parameter; sending the standard command frame with the execution parameter to the standard interface; and storing the execution parameter to a corresponding register of the standard interface. After that, a control unit of the standard interface is used to detect the corresponding register and drive the standard interface to perform a nonstandard function corresponding to the execution parameter when the execution parameter is found.

Furthermore, the present invention further includes setting a no-available parameter of a standard command frame as an activation parameter; and sending this standard command frame having the activation parameter to the standard interface; and storing the activation parameter to a corresponding register of the standard interface. Therein, when the standard interface finds the activation parameter, the standard interface confirms that a nonstandard function needs to be performed.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an example of the standard NOP command frame in accordance with the prior art;

FIG. 2 is a flow chart of a preferred embodiment in accordance with the method of the present invention;

FIG. 3A shows a standard NOP command frame having an execution parameter in accordance with a preferred embodiment of the present invention;

FIG. 3B shows a standard NOP command frame having an activation parameter in accordance with a preferred embodiment of the present invention;

FIGS. 4A-4C show standard NOP command frames respectively having activation parameters in accordance with another preferred embodiment of the present invention;

FIG. 5 is a flow chart of another preferred embodiment in accordance with the method of the present invention; and

FIG. 6 shows a standard NOP command frame having activation and execution parameters in accordance with a preferred embodiment of the present invention.

### DETAILED DESCRIPTION OF PREFERRED EMBODIMENTS

The following embodiments use a standard interface having an updateable firmware for performing nonstandard functions. In the prior art, some values of the Command register parameter reserved in the interface standard are used to define Vender Specific Commands. The present invention is different to the prior art. It uses the “na” parameters of the standard command frame provided in the interface standard to define the commands of nonstandard functions. Thus, the present invention can perform the standard functions according to the standard command frame defined in the interface standard and the nonstandard functions according to the “na” parameters.

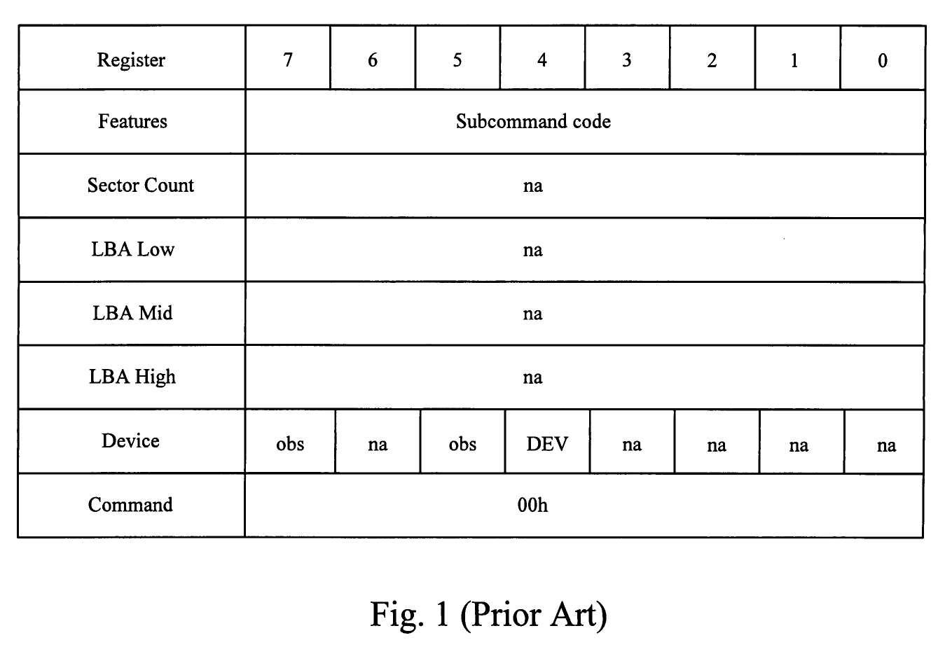

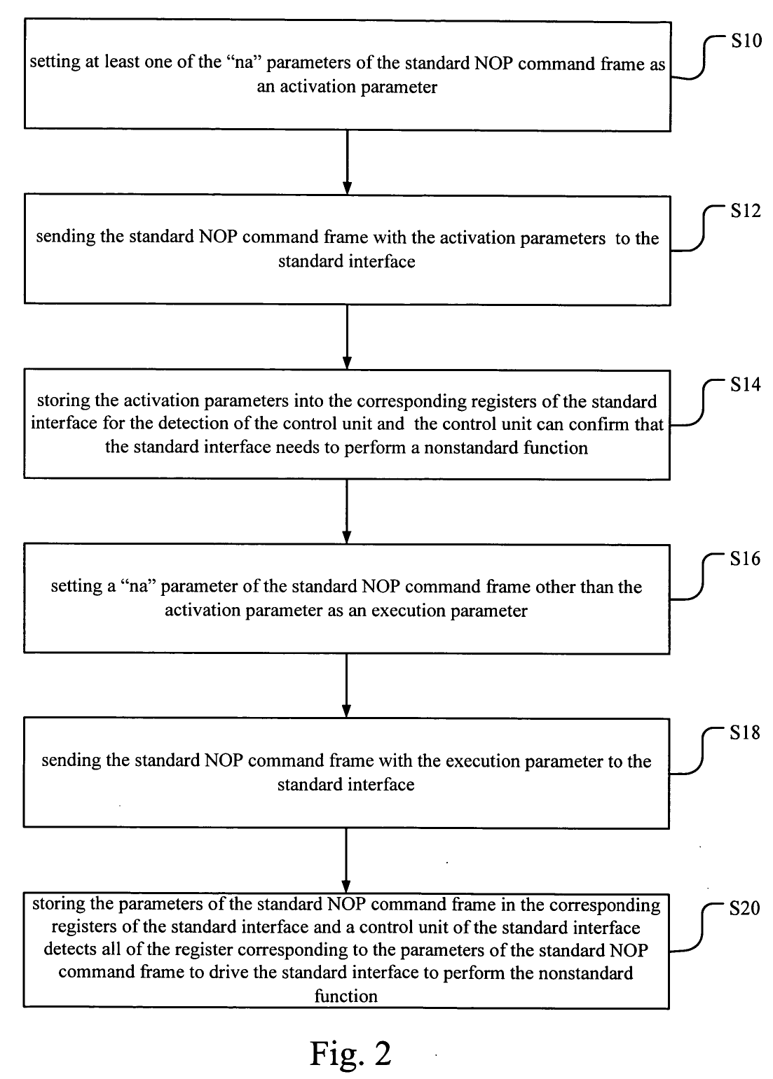

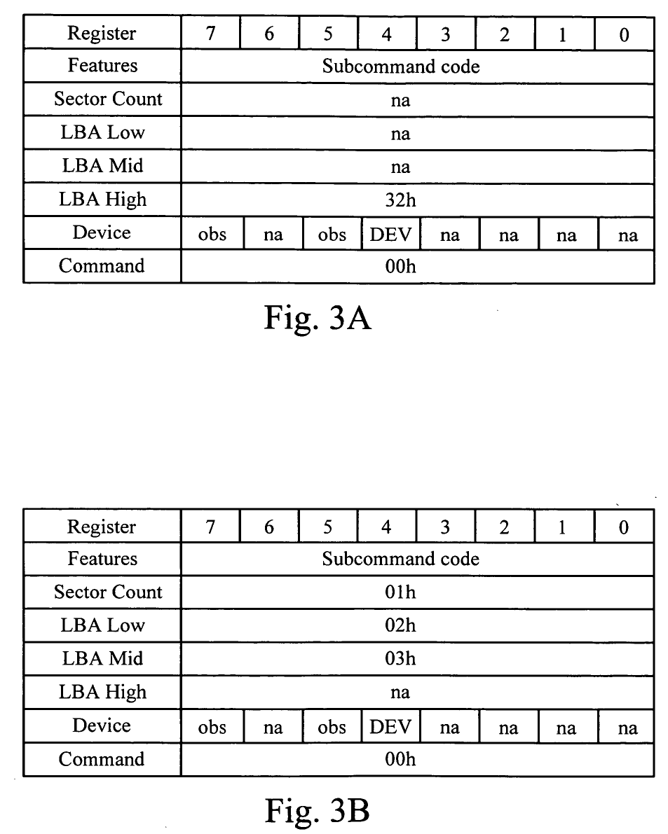

Reference is made to FIG. 2, which is a flow chart of a preferred embodiment in accordance with the method of the present invention. This embodiment uses a standard ATA/ATAPI NOP command frame as an example. When the standard interface needs to be driven to perform a nonstandard function, a “na” parameter of the standard NOP command frame shown in FIG. 1 is used as an execution parameter and set (step S16). In order to further clarify this step, please refer to FIG. 3A, which shows an embodiment using the LBA High register parameter as the execution parameter and the execution parameter is set as 32h.

Subsequently, the standard NOP command frame with the execution parameter is sent to the standard interface (step S18). Then, the parameters of the standard NOP command frame are stored in the corresponding registers of the standard interface and a control unit of the standard interface detects all of the register corresponding to the parameters of the standard NOP command frame to drive the standard interface to perform the nonstandard function. Please refer to FIG. 3A. All of the registers corresponding to the parameters of the standard NOP command frame shown in FIG. 3 are detected. When the control unit finds the value of the LBA High register parameter is 32h, it updates the firmware to promote the functionality of the standard interface so as to perform the nonstandard function.

Since the LBA High register parameter of the standard NOP command frame corresponding to standard functions can be set randomly according to the interface standard, the value of the LBA High register parameter may happens to be the same as that of the execution parameter. It will cause the control unit to erroneously determine that the standard interface needs to be driven to perform the nonstandard function. In order to avoid the occurrence of this situation, the present invention further includes following steps, which need to be performed before step S16.

In order to confirm that the standard interface needs to perform a nonstandard function, at least one of the “na” parameters of the standard NOP command frame other than the execution parameter is used as an activation parameter (step S10). For further clarifying this step, please refer to FIG. 3B. As shown in the figure, the “na” parameters, i.e. Sector Count register parameter, LBA Low register parameter and LBA Mid register parameter, are used as the activation parameters and set as 01h, 02h and 03h, respectively.

After that, the standard NOP command frame with the activation parameters are sent to the standard interface (step S12). Then, the activation parameters are stored into the corresponding registers of the standard interface for the detection of the control unit (step S14). When the control unit finds that the values stored in the Sector Count register, the LBA Low register and the LBA Mid register are 01h, 02h and 03h respectively, the control unit can confirm that the standard interface needs to perform a nonstandard function. After the confirmation, steps 16-20 will be performed and the standard interface will update its firmware to perform the nonstandard function. However, if the control unit finds that the values stored in the Sector Count register, the LBA Low register and the LBA Mid register are not 01h, 02h and 03h, the interface will not perform the nonstandard function even though it receives the standard NOP command frame with the execution parameter.

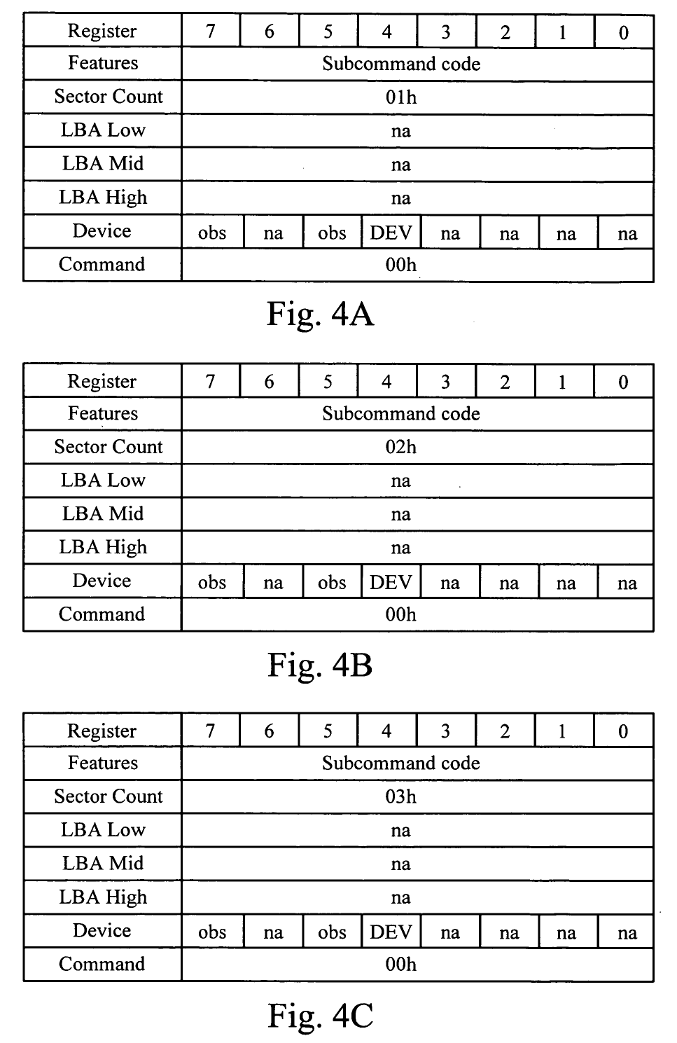

Furthermore, the present invention also provides another method for setting the activation parameters so that the standard interface can confirm that the nonstandard function needs to be performed. This method is to set a specific “na” parameter of multiple standard NOP command frames as the activation parameter and send these command frames out one by one. Reference is made to FIG. 4A˜4C, which show an embodiment for the multiple standard NOP command frames in accordance with the present invention. Therein, the present invention uses three standard NOP command frames and sets their Sector Counter register parameters (activation parameters) as 01h, 02h and 03h respectively. After that, the present invention sends these command frames to the standard interface one by one. Each time when the standard interface receives a standard NOP command frame, it stores the activation parameter of the command frame to the corresponding register for the detection of the control unit. When the control unit finds that the value stored in the Sector Count register is changed as 01h, 02h and 03h in order, it can confirm that the standard interface needs to perform the nonstandard function.

The method of the present invention using the “na” parameters to drive the standard interface to perform the nonstandard function can be applied to the devices complying with the standard interface specification such as the specification of ATA or ATAPI standard. Besides, the present invention can also be applied to other devices using command frames with “na” parameters.

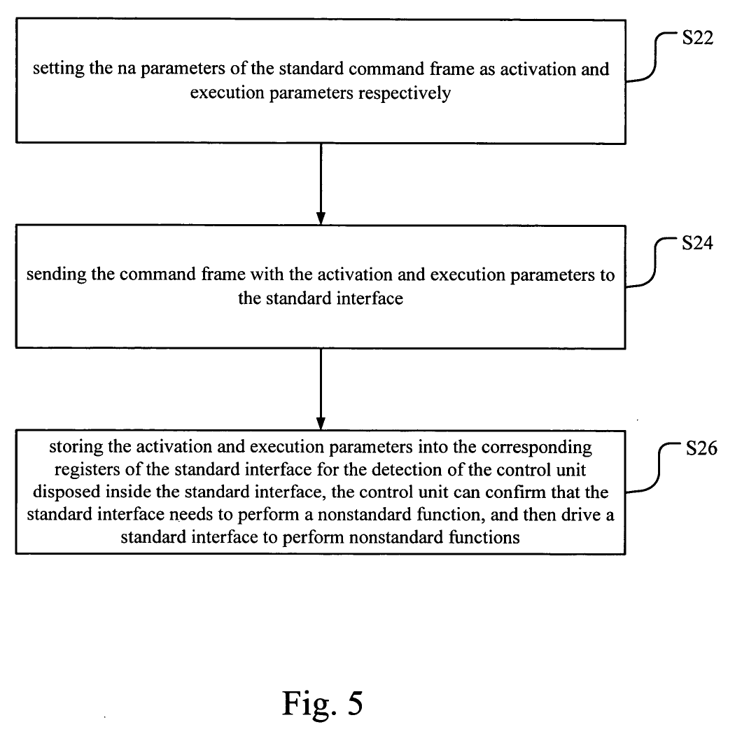

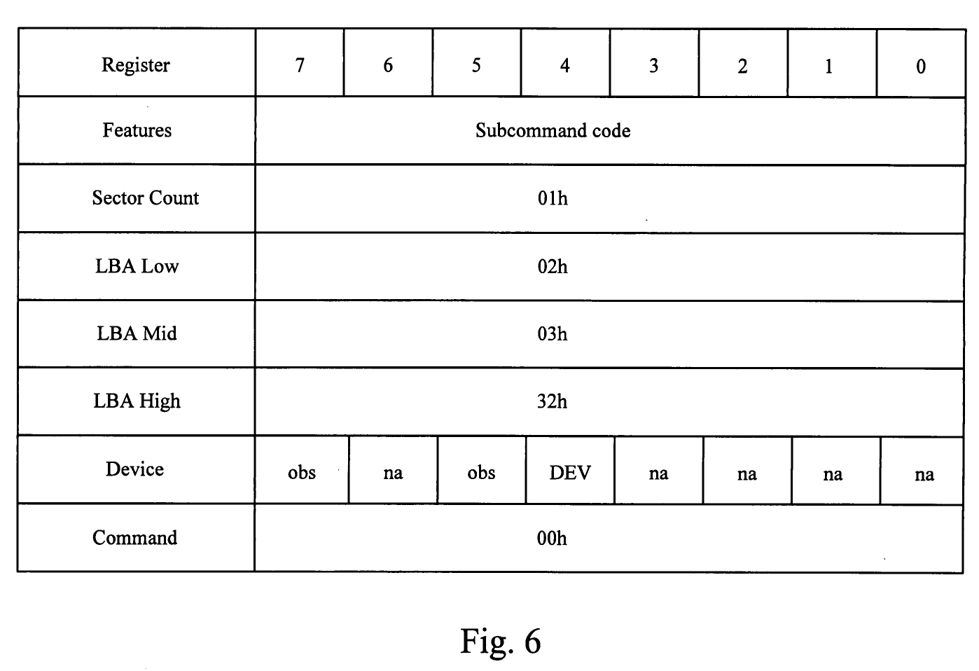

Reference is made to FIG. 5, which is a flow chart of another preferred embodiment in accordance with the method of the present invention. This embodiment uses a standard command frame with multiple “na” parameters to drive a standard interface to perform nonstandard functions. First, the present invention sets the “na” parameters of the standard command frame as activation and execution parameters respectively (step S22). In order to clarify this step, please refer to FIG. 6. Therein, the present invention sets the Sector Count register parameter, the LBA Low register parameter and the LBA Mid register parameter of the standard NOP command frame as the activation parameters. Their values are 01h, 02h and 03h, respectively. In addition, the present invention sets the LBA High register parameter as the execution parameter and its value is 32h.

After that, the command frame with the activation and execution parameters is sent to the standard interface (step S24). Then, the activation and execution parameters are stored into the corresponding registers of the standard interface for the detection of the control unit disposed inside the standard interface. Thereby, the control unit can confirm that the standard interface needs to update its firmware to perform a nonstandard function.

Summing up, the present invention is related to a method for driving a standard interface to perform nonstandard functions. It first sets some “na” parameters of the standard command frame as activation parameters for the control unit to detect and thereby confirm that the standard interface needs to perform a nonstandard function. In this way, it can prevent the standard interface from performing the nonstandard function unexpectedly. After that, the present invention also sets a specific “na” parameter of the standard command frame as an execution parameter. When the control unit of the standard interface finds the execution parameter, it drives the standard interface to perform the corresponding nonstandard function. Thereby, the present invention provides a novel way to define the command frames for driving the standard interface to perform nonstandard functions and improve the flexibility of the standard interface.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A method for driving a standard interface to perform nonstandard functions, the method uses a first standard command frame with a first no-available parameter to drive the standard interface to perform a corresponding one of the nonstandard functions, the method comprising:
setting the first no-available parameter of the first standard command frame as an execution parameter; and
sending the first standard command frame with the execution parameter to the standard interface;
wherein when the standard interface finds the execution parameter, the standard interface is driven to perform the corresponding one of the nonstandard functions.

2. The method as claimed in claim 1, wherein the step of sending the first standard command frame with the execution parameter to the standard interface further comprises:
storing the execution parameter to a first register of the standard interface for detection of a control unit of the standard interface.

3. The method as claimed in claim 1, wherein before the step of setting the first no-available parameter of the first standard command frame as the execution parameter is performed, the method further comprises:
setting a second no-available parameter of a second standard command frame as an activation parameter; and
sending the second standard command frame with the activation parameter to the standard interface;
wherein when the standard interface finds the activation parameter, the standard interface confirms that the corresponding one of the nonstandard functions needs to be performed.

4. The method as claimed in claim 3, wherein the step of sending the second standard command frame with the activation parameter to the standard interface further comprises:
storing the activation parameter to a second register of the standard interface for detection of a control unit of the standard interface.

5. The method as claimed in claim 1, wherein the standard interface complies with an Advanced Technology Attachment (ATA) standard.

6. The method as claimed in claim 1, wherein the standard interface complies with an ATA Packet Interface (ATAPI) standard.

7. A method for driving a standard interface to perform nonstandard functions, the method uses a standard command frame with a plurality of no-available parameters to drive the standard interface to perform a corresponding one of the nonstandard functions, the method comprising:
setting the no-available parameters of the standard command frame as execution and activation parameters respectively; and
sending the standard command frame with the execution and activation parameters to the standard interface;
wherein when the standard interface finds the activation and execution parameters, the standard interface confirms that the corresponding one of the nonstandard functions needs to be performed and then performs the corresponding one of the nonstandard functions.

8. The method as claimed in claim 7, wherein the step of sending the standard command frame with the execution and activation parameters to the standard interface further comprises:
storing the activation parameter to a first register of the standard interface for detection of a control unit of the standard interface; and
storing the execution parameter to a second register of the standard interface for detection of the control unit of the standard interface.

9. The method as claimed in claim 7, wherein the standard interface complies with an ATA standard.

10. The method as claimed in claim 7, wherein the standard interface complies with an ATAPI standard.
